(19) United States
(12) Patent Application Publication
(10) Pub. No.: US 2026/0290259 A1
(43) Pub. Date: Sep. 24, 2026

(54) DISPLAY DEVICE AND DRIVING METHOD THEREOF

(71) Applicant: LG Display Co., Ltd., Seoul (KR)

(72) Inventor: Woo Kyu SANG, Paju-si (KR)

(21) Appl. No.: 19/363,852

(22) Filed: Oct. 21, 2025

(30) Foreign Application Priority Data
Mar. 20, 2025 (KR) 10-2025-0035713

(51) Int. Cl. G09G 3/3275; G09G 3/32; G09G 3/3266

(52) U.S. Cl. CPC G09G 3/3275; G09G 3/32; G09G 3/3266; G09G 2300/043; G09G 2300/0819; G09G 2310/0245; G09G 2310/0267; G09G 2310/0275; G09G 2310/08; G09G 2320/0233; G09G 2330/021

(57) ABSTRACT

A display panel of the display device includes a first sub-display area including a plurality of pixels which are driven at a first refresh rate and to which a compensation voltage at a first voltage level is applied; and a second sub-display area including a plurality of pixels which are driven at a second refresh rate and to which the compensation voltage at a second voltage level is applied. The compensation voltage increases or decreases between the first voltage level and the second voltage level within a voltage variable interval set to a size including a plurality of pixel lines.

### CROSS REFERENCE TO RELATED APPLICATION

This application claims priority from and the benefit of Korean Patent Application No. 10-2025-0035713, filed on Mar. 20, 2025, which is hereby incorporated by reference for all purposes as if fully set forth herein.

### BACKGROUND

### FIELD

Embodiments of the invention relate generally to a display device that supports a variable refresh rate (VRR), and a driving method of the display device.

### DISCUSSION OF THE BACKGROUND

Various flat panel displays such as a liquid crystal display and an electroluminescence display are known. The electroluminescence display may use light-emitting elements provided in each of pixels to emit light by itself without a backlight and may display an input image. The light-emitting elements of the electroluminescence display may be divided into organic light-emitting elements and inorganic light-emitting elements depending on a material for a light-emitting layer. An active matrix type electroluminescence display has advantages of a high response speed, high light emission efficiency, high luminance, and a wide viewing angle since an organic light emitting diode (hereinafter, referred to as an "OLED") is provided in each pixel, and is excellent in contrast ratio and color reproducibility since a black grayscale can be expressed as complete black.

Recently, a display device supports a variable refresh rate (VRR). The variable refresh rate may cause luminance deviation of an image that is displayed on the display panel. For example, when a screen of the display panel is divided into pixel areas with different refresh rates and driven, and a frame data of the image is reproduced on the screen, a luminance difference may be visually recognized in one screen.

The above information disclosed in this Background section is only for understanding of the background of the inventive concepts, and, therefore, it may contain information that does not constitute prior art.

### SUMMARY

Embodiments of the present disclosure solve the above-described shortcomings and/or problems.

A display device and a driving method thereof according to embodiments of the invention are capable of reducing a luminance difference when pixels are driven at a variable refresh rate.

Additional features of the inventive concepts will be set forth in the description which follows, and in part will be apparent from the description, or may be learned by practice of the inventive concepts.

A display device according to one embodiment includes: a display panel in which a plurality of data lines, a plurality of gate lines, a plurality of power lines, and a plurality of pixel lines are provided; a data driver electrically connected to the data lines; a gate driver electrically connected to the gate lines; a power supply configured to drive the display panel and configured to vary voltage levels of one or more compensation voltages in response to voltage control data within a voltage variable interval; and a timing controller configured to control the data driver, the gate driver, and the power supply. The display panel includes: a first sub-display area including a plurality of pixel lines which are driven at a first driving frequency according to a first refresh rate and to which the compensation voltage at a first voltage level is applied; and a second sub-display area including a plurality of pixel lines which are driven at a second driving frequency according to a second refresh rate and to which the compensation voltage at a second voltage level is applied. Some pixel lines of the first sub-display area and some pixel lines of the second sub-display area are driven within the voltage variable interval. The compensation voltage increases or decreases between the first voltage level and the second voltage level within the voltage variable interval set to a size including a plurality of pixel lines.

Four to sixteen pixel lines may be driven within the voltage variable interval. A voltage level of the compensation voltage that changes in units of one or sixteen horizontal periods may gradually increase or decrease between the first voltage level and the second voltage level within the voltage variable interval.

A scanning may start in one of the first sub-display area and the second sub-display area within the voltage variable interval.

The voltage variable interval may become greater as a difference between a refresh rate of the first sub-display area and a refresh rate of the second sub-display area become greater.

The power lines may include a plurality of compensation voltage lines parallel to the gate lines.

While the compensation voltage having the first voltage level may be applied to the compensation voltage lines of the first sub-display area, the compensation voltage having the second voltage level may be applied to the compensation voltage lines of the second sub-display area.

The power supply may be configured to output the compensation voltage having the first voltage level, and the compensation voltage having the second voltage level. The timing controller may change the voltage control data within the voltage variable interval.

The power lines may include a plurality of compensation voltage lines parallel to the gate lines. The gate driver may include a voltage selection circuit electrically connected to the plurality of compensation voltage lines. The voltage selection circuit may be configured to select the first voltage level and the second voltage level based on a refresh rate.

The one or more compensation voltages may include a first compensation voltage and a second compensation voltage. Each of the pixel lines includes a plurality of subpixels. Each of the subpixels may include: a driving transistor including a gate electrode connected to a first node, a first electrode connected to a second node, and a second electrode connected to a third node; a light-emitting diode including an anode electrode connected to a fourth node and a cathode electrode connected to a second power line to which a pixel ground voltage is applied; a first switch transistor connected between the first node and the third node and turned on in response to a first scan signal; a second switch transistor connected between a corresponding data line and the second node and turned on in response to a second scan signal; a third switch transistor connected between a first power line to which a pixel driving voltage is applied and the second node and turned on in response to an emission control signal; a fourth switch transistor connected between the third node and the fourth node and turned on in response to the emission control signal; a fifth switch transistor connected between the second node and a third power line to which the first compensation voltage is applied and turned on in response to a third scan signal to apply the first compensation voltage to the second node; a sixth switch transistor connected between the fourth node and a fourth power line to which the second compensation voltage is applied and turned on in response to a third scan signal to apply the second compensation voltage to the fourth node; and a seventh switch transistor connected between the first node and a fifth power line to which an initialization voltage is applied and turned on in response to a fourth scan signal. At least one of the third power line and the fourth power line may be a compensation voltage line, which is separated in units of one or more pixel lines. The compensation voltage of different voltage levels may be applied to pixel lines having different driving frequencies via the compensation voltage line.

The one or more compensation voltages include a first compensation voltage and a second compensation voltage. Each of the subpixels may include: a driving transistor including a gate electrode connected to a first node, a first electrode connected to a second node, and a second electrode connected to a third node; a light-emitting diode including an anode electrode connected to a fourth node and a cathode electrode connected to a second power line to which a pixel ground voltage is applied; a first switch transistor connected between the first node and the third node and turned on in response to a first scan signal; a second switch transistor connected between a corresponding data line and the second node and turned on in response to a second scan signal; a third switch transistor connected between a first power line to which a pixel driving voltage is applied and the second node and turned on in response to an emission control signal; a fourth switch transistor connected between the third node and the fourth node and turned on in response to the emission control signal; a fifth switch transistor connected between the second node and a third power line to which the first compensation voltage and an initialization voltage are applied and turned on in response to a third scan signal to apply the first compensation voltage and the initialization voltage to the third node; and a sixth switch transistor connected between the fourth node and a fourth power line to which the second compensation voltage is applied and turned on in response to the third scan signal to apply the second compensation voltage to the fourth node. At least one of the third power line and the fourth power line may be a compensation voltage line, which is separated in units of one or more pixel lines. The compensation voltage of different voltage levels may be applied to pixel lines having different driving frequencies via the compensation voltage line.

A refresh rate of the first sub-display area may be different from a refresh rate of the second sub-display area. The first compensation voltage may increase within the voltage variable interval.

The second compensation voltage may decrease within the voltage variable interval.

A display device according to another embodiment includes: a display panel in which a plurality of data lines, a plurality of gate lines, a plurality of power lines, and a plurality of pixel lines are provided; a data driver electrically connected to the data lines; a gate driver electrically connected to the gate lines; a power supply configured to drive the display panel and configured to vary voltage levels of one or more compensation voltages in response to voltage control data; and a timing controller configured to control the data driver, the gate driver, and the power supply. The display panel includes: a first sub-display area including a plurality of pixel lines that are driven at a first refresh rate; and a second sub-display area including a plurality of pixel lines that are driven at a second refresh rate. On-bias periods during which the compensation voltage is applied to the pixel lines are sequentially shifted in the first sub-display area and the second sub-display area along a scanning direction of the display panel.

A voltage level of the compensation voltage may be simultaneously changed in the first sub-display area and the second sub-display area.

A method of driving a display device according to one embodiment includes: while driving pixel lines of a first sub-display area to display an image at a first refresh rate in the first sub-display area, driving pixel lines of a second sub-display area to display the image at a second refresh rate in the second sub-display area; setting a compensation voltage that is applied to the pixel lines of the first sub-display area, as a first voltage level; setting a compensation voltage that is applied to the pixel lines of the second sub-display area, as a second voltage level; and setting a boundary area including some pixel lines of the first sub-display area and some pixel lines of the second sub-display area as a voltage variable interval. The compensation voltage increases or decreases between the first voltage level and the second voltage level within the voltage variable interval.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a schematic block diagram illustrating a display device according to an embodiment of the present disclosure.

FIG. 2 is a schematic diagram illustrating an example where output voltages of a power supply are varied according to voltage control data.

FIG. 3 is a schematic circuit diagram illustrating a pixel circuit according to the embodiment of the present disclosure.

FIG. 4 is a schematic waveform chart illustrating driving signals that are applied to the pixel circuit illustrated in FIG. 3 in a refresh period and a skip period.

FIG. 5 is a schematic circuit diagram illustrating a pixel circuit according to another embodiment of the present disclosure.

FIG. 6 is a schematic waveform chart illustrating driving signals that are applied to the pixel circuit illustrated in FIG. 5 in a refresh period and a skip period.

FIG. 7 is a schematic diagram illustrating an example of a display panel that is driven at multiple frequencies in one frame period.

FIG. 8 is a schematic simulation result illustrating a threshold voltage of a driving element for refresh driving and skip driving of the pixel circuit illustrated in FIG. 3.

FIG. 9 is a schematic diagram illustrating an example where a luminance difference between display areas with different refresh rates is reduced by decreasing a second compensation voltage to be applied to a sub-display area with a low refresh rate lower than a second compensation voltage to be applied to a sub-display area with a high refresh rate.

FIGS. 10, 11, 12, and 13, are schematic waveform charts illustrating a control method of pixel compensation voltages according to various embodiments of the present disclosure.

FIG. 14 is a schematic block diagram illustrating a voltage selection circuit according to the embodiment of the present disclosure.

FIG. 15 is a schematic circuit diagram illustrating an example of a voltage selector illustrated in FIG. 14.

FIGS. 16, 17, 18, 19, 20, 21, and 22, are schematic waveform charts illustrating various embodiments in which compensation voltages are differentially applied to sub-display areas with different refresh rates to perform luminance adjustment between the sub-display areas.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z – axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

Components are interpreted to include an ordinary error range even if not expressly stated.

When a temporal antecedent relationship is described, such as “after”, “following”, “next to”, “before”, or the like, it may not be continuous on a time base unless “immediately” or “directly” is used.

The following embodiments can be partially or entirely bonded to or combined with each other and can be linked and operated in technically various ways. The embodiments can be carried out independently of or in association with each other.

The pixel circuit and the gate drive circuit of the display device may include a plurality of transistors. The transistor may be implemented as a thin film transistor (TFT). The transistors may be implemented as an oxide thin film transistor (Oxide TFT) including an oxide semiconductor, a low-temperature poly silicon TFT (LTPS TFT) including a low-temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor), since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage, and the gate-off voltage may be a gate low voltage VGL. In the case of a p-channel transistor, the gate-on voltage may be the gate low voltage VGL, and the gate-off voltage may be the gate high voltage.

Hereinafter, various embodiments of the present disclosure will be described in detail with reference to the accompanying drawings.

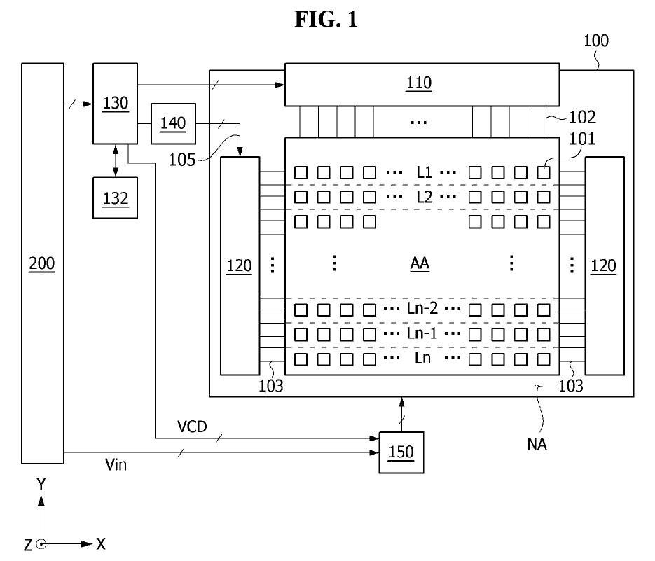

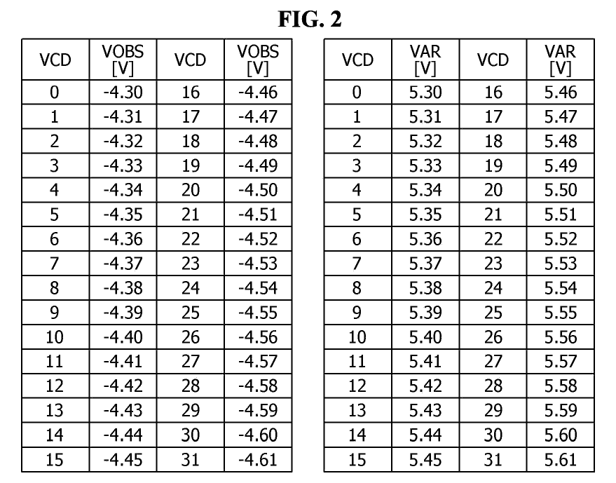

FIG. 1 is a schematic diagram illustrating a display device according to an embodiment of the present disclosure. FIG. 2 is a schematic diagram illustrating an example where output voltages of a power supply are varied according to voltage control data.

Referring to FIG. 1, the display device according to the embodiment of the present disclosure may include a display panel 100, a display panel driving circuit 110 and 120 that write pixel data to pixels 101 of the display panel 100, a power supply 150 that generates power necessary for driving the pixels 101 and the display panel driving circuit 110 and 120, and the like.

The display panel 100 may be a rectangular panel having a breadth (or a width) in the X-axis direction, a length in the Y-axis direction, and a thickness in the Z-axis direction, but is not limited thereto. A screen of the display panel 100 may include a display area AA and a non-display area NA disposed adjacent to the display area AA. The display area AA of the display panel 100 may include a pixel array that displays an image (or input image). The pixel array may include a plurality of data lines 102 extending in the Y-axis direction, a plurality of gate lines 103 extending in the X-axis direction and intersecting the data lines 102, and pixels provided in a matrix. The display panel 100 may further include power lines connected in common to two or more pixels. The power lines may be electrically connected in common to pixel circuits and may supply voltages necessary for driving the pixels 101 to the pixels 101.

The power lines may include compensation voltage lines separated in units of one or more pixel lines. For at least one pixel compensation voltage to be applied to the pixels, pixel compensation voltages whose voltage levels are varied in units of pixel line, for example, VOBS [V] and VAR [V] illustrated in FIG. 2 may be supplied to the pixels via the compensation voltage lines separated between the pixel lines.

The data lines 102 may be provided in the form of long wires in the Y-axis direction of the display panel 100 and be electrically connected to data channels of a data driver 110. The gate lines 103 may be provided in the form of long wires in the X-axis direction of the display panel 100, intersect the data lines 102, and be electrically connected to output terminals of a gate driver 120.

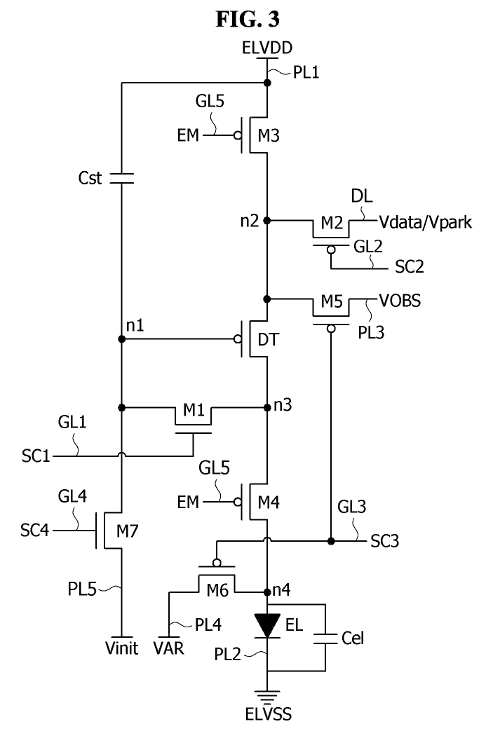

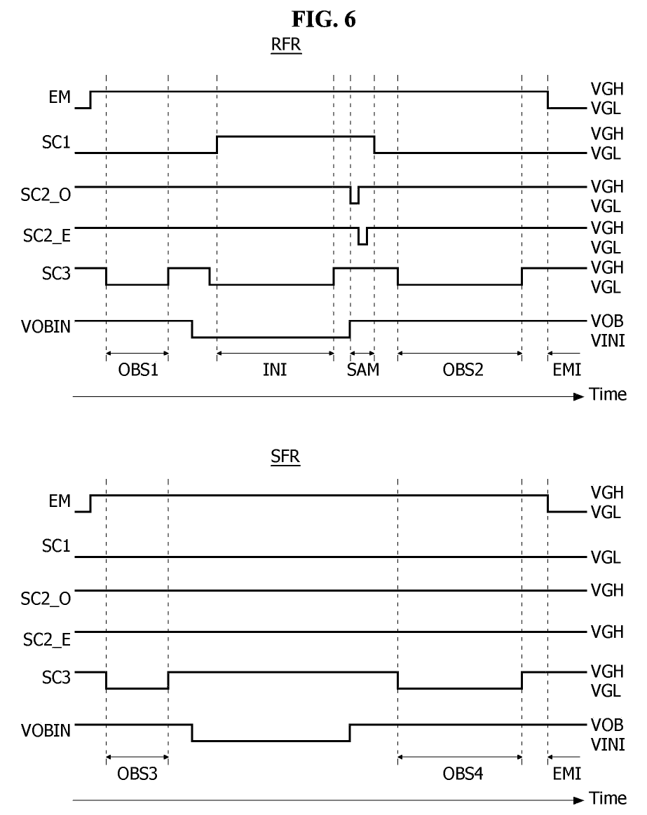

Each of the pixels 101 may be divided into a red subpixel, a green subpixel, and a blue subpixel for color implementation. Each of the pixels may further include a white subpixel. Each of the subpixels may include a pixel circuit for driving a light-emitting element. Each pixel circuit may be connected to the data lines, the gate lines, and the power lines. The pixel circuit may be implemented by a circuit illustrated in FIGS. 3 or 6, but embodiments of the present disclosure are not limited thereto.

The pixel array may include a plurality of pixel lines L1 to Ln. Each of the pixel lines L1 to Ln may include one line of pixels provided in the X-axis direction in the pixel array of the display panel 100. The pixels may be provided in one pixel line share the gate line 103. The subpixels may be provided in the Y-axis direction along the data line share the same data line 102. One horizontal period 1 H may be a time obtained by dividing one frame period by the total number of pixel lines L1 to Ln.

The display panel 100 may be implemented as a non-transmissive display panel or a transmissive display panel. The transmissive display panel may be applied to a transparent display device in which an image is displayed on a screen and a real background is visible. The display panel 100 may be manufactured as a flexible display panel.

The power supply 150 may adjust a level of a direct-current input voltage Vin that is applied from a host system 200 and output a first voltage V1 necessary for driving the pixel array and the display panel driving circuit of the display panel 100. The power supply 150 may include a DC-DC converter. The DC-DC converter may include a charge pump, a regulator, a buck converter, a boost converter, and the like. The power supply 150 may output a gamma reference voltage, a gate high voltage, a gate low voltage, a pixel driving voltage, a pixel ground voltage, pixel compensation voltages, an integrated circuit (IC) driving voltage, and the like via the DC-DC converter. The voltages that are output from the power supply 150 may be constant voltages (or direct-current voltages), but embodiments of the present disclosure are not limited thereto. The gamma reference voltage may be supplied to the data driver 110. A dynamic range of a data voltage that is output from the data driver 110 may be set according to a voltage range of the gamma reference voltage. The dynamic range of the data voltage may have a voltage value between a highest grayscale voltage and a lowest grayscale voltage.

The gate high voltage and the gate low voltage may be supplied to a level shifter 140 and the gate driver 120. The voltages such as the pixel driving voltage, the pixel ground voltage, and the pixel compensation voltages may be supplied to the pixels 101. The IC driving voltage may be a driving voltage of a drive IC embedded with circuits such as a timing controller 130 and the data driver 110.

The power supply 150 may adjust the output voltages under the control of the timing controller 130. For example, the power supply 150 may be electrically connected to the timing controller 130 via a wire in which a signal is transmitted through a serial interface such as I2C or a serial peripheral interface bus (SPI). The power supply 150 may adjust the output voltages in response to voltage control data VCD received from the timing controller 130. The voltage control data VCD may include digital-to-analog converter (hereinafter, referred to as "'DAC") data code or a set code of a register embedded in the power supply 150 and instructs a voltage level. The DAC of the power supply 150 may receive the DAC data code from the timing controller 130 as input and may adjust or change a voltage level of an output voltage. The register of the power supply 150 may control a multiplexer to select a voltage to be output via the multiplexer and may adjust or change a voltage level of an output voltage.

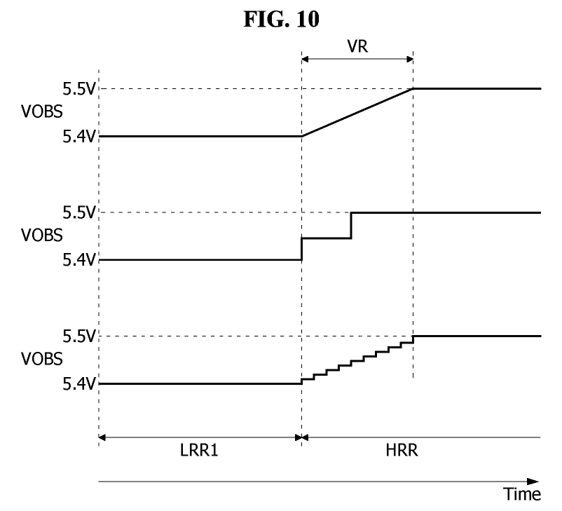

The timing controller 130 may be implemented as an application-specific integrated circuit (ASIC), and the power supply 150 may be implemented as a power IC such as a power management integrated circuit (PMIC) or an electronics integrated circuit (ELIC). The power supply 150 may vary and output the voltage levels of the pixel compensation voltages VOBS and VAR in response to the voltage control data VCD received from the timing controller 130 as illustrated in FIG. 2. A signal transmission speed of the I2C may be a maximum of about 400 [kbps], and a transmission speed of the SPI may be is about 10 to about 100 [Mpbs]. The voltage control data VCD may be transmitted to the power supply 150 at this transmission speed. As a result, the voltage levels of the pixel compensation voltages VOBS and VAR may be varied in units of one to four horizontal periods. The pixel compensation voltages VOBS and VAR output from the power supply 150 may be applied to the pixels 101 via the power lines separated in units of pixel line. The timing controller 130 may perform control such that the voltage level of the pixel compensation voltage gradually increases or decreases in units of horizontal period within a voltage variable interval VR illustrated in FIGS. 10, 11, 12, and 13 by changing the voltage control data VCD within the voltage variable interval VR.

The display panel driving circuit 110 and 120 may write pixel data of an image to the pixels of the display panel 100 under the control of the timing controller 130. The display panel driving circuit 110 and 120 may include the data driver 110 and the gate driver 120. The display panel driving circuit 110 and 120 may further include de-multiplexers (DEMUX) provided between the data driver 110 and the data lines 102, but embodiments of the present disclosure are not limited thereto. When the de-multiplexers are provided between output terminals of the data driver 110 and the data lines 102, the number of channels (or the number of output terminals) of the data driver 110 to be electrically connected to the data lines 102 may be reduced.

Touch sensors for sensing a touch input may be provided on the display panel 100. The touch sensors may be provided on the display panel 100 as an on-cell type or add on type or may be implemented as in-cell type touch sensors embedded in the pixel array.

The display panel driving circuit 110 and 120 may further include a touch sensor driver that drives the touch sensors. The touch sensor driver is not illustrated in FIG. 1. The data driver 110 and the touch sensor driver may be integrated in one drive IC.

The data driver 110 may be electrically connected to the data lines 102 and output a data voltage corresponding to pixel data of the image. Each of the channels of the data driver 110 may receive pixel data of the input data transmitted from the timing controller 130 as a digital signal and output a data voltage.

The channels of the data driver 110 may convert pixel data of the image received from the timing controller 130 into a gamma compensation voltage using a DAC and may output a data voltage of pixel data. The DAC of the data driver 110 may be provided separately from the DAC of the power supply 150. The data driver 110 may divide the gamma reference voltage input from the power supply 150 into gamma compensation voltages having different voltage levels by grayscale using a voltage distribution circuit (or a voltage division circuit). The gamma compensation voltages may be provided to the DAC of the data driver 110. The data voltage may be output from each of the channels of the data driver 110 via an output buffer.

The gate driver 120 may be provided on at least one non-display area NA of right and left sides outside the display area AA in the display panel 100 or at least a part of the gate driver 120 may be provided in the display area AA.

The gate driver 120 may be provided in the non-display areas NA on both sides of the display panel 100 with the display area AA of the display panel interposed therebetween and may supply gate pulses on both sides of the gate lines 103 by a double feeding method. The gate driver 120 may sequentially output pulses of gate signals to the gate lines 103 under the control of the timing controller 130. The gate driver 120 may sequentially supply the gate signals to the gate lines 103 by shifting the pulses of the gate signals using a shift register or an edge trigger. The gate driver 120 may include a plurality of gate drivers. Each of the gate drivers may be implemented as a shift register or an edge trigger.

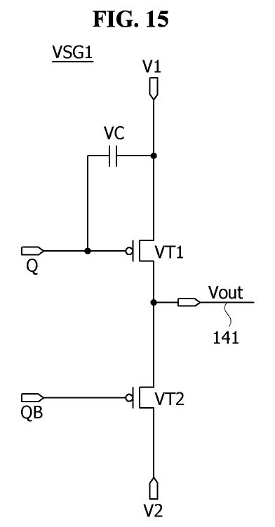

The gate signals necessary for driving the pixel circuit may include a first scan signal, a second scan signal, a third scan signal, and an emission control signal (hereinafter, referred to as an "'EM signal"). For example, the gate driver 120 may include a plurality of gate drivers. The gate driver 120 may further include a voltage selection circuit (see FIGS. 14 and 15) that varies the pixel compensation voltages VOBS and VAR according to a variable refresh rate.

The timing controller 130 may receive digital video data of an image from the host system 200 and a timing signal synchronized with the data. The timing signal may include a vertical synchronization signal Vsync, a horizontal synchronization signal Hsync, a data enable signal DE, and the like. Since a vertical period and a horizontal period are known by a method of counting the data enable signal DE, the vertical synchronization signal Vsync and the horizontal synchronization signal Hsync may be omitted. The horizontal synchronization signal Hsync and the data enable signal DE may have a cycle of one horizontal period 1 H. A data voltage of pixel data may be charged simultaneously in subpixels provided in one pixel line in one horizontal period 1 H, and pixel data may be written to the subpixels.

The timing controller 130 may generate a data timing control signal for controlling an operation timing of the data driver 110 and a gate timing control signal for controlling an operation timing of the gate driver 120 on the basis of the timing signal (Vsync, Hsync, DE) received from the host system 200. The timing controller 130 may control the operation timing of the display panel driving circuit to synchronize the data driver 110 and the gate driver 120.

The gate timing control signal output from the timing controller 130 may be input to the shift register and/or the edge trigger of the gate driver 120 via the level shifter 140. The level shifter 140 may convert the gate timing control signal received from the timing controller 130 via a clock line 105 to have a swing width between a gate high voltage and a gate low voltage and may provide the converted gate timing control signal to the gate driver 120. The gate timing control signal output from the level shifter 140 may include a start signal, a clock, and the like, but embodiments of the present disclosure are not limited thereto. The gate driver 120 may output the pulses of the gate signals for writing pixel data to the subpixels during a display period in response to the gate timing control signal input from the level shifter 140.

The display panel driving circuit 110 and 120 may drive the pixels 101 at a variable refresh rate under the control of the timing controller 130. The timing controller 130 may decrease a refresh rate of an image displayed on the display panel 100 according to a frequency of an image or on the basis of an analysis result of the image to reduce the power consumption of the display device and improve image quality. The variable refresh rate may refer to varying a refresh frequency of pixels to about 1 Hz, about 30 Hz, about 60 Hz, about 120 Hz, about 144 Hz, about 165 Hz, about 240 Hz, and the like, but embodiments of the present disclosure are not limited thereto.

The refresh frequency may be a pixel driving frequency that is generated when pixel data is written by frames per second (FPS) that changes in conformity with the variable refresh rate. Meanwhile, a skip frequency may be a pixel driving frequency at which new pixel data is not written and a data voltage of pixel data charged in a previous refresh period is maintained. When the pixels are driven by skip driving, since the initialization of the pixels and a data writing step are not performed, power consumption in the display panel 100 and the display panel driving circuit 110 and 120 during skip driving may be significantly small compared to during refresh driving.

The variable refresh rate may vary a frame refresh rate per second of an image that is produced on the screen of the display panel 100, in real time, instead of maintaining the frame refresh rate per second to a fixed value. In displaying an image of contents such as a game or an animation on the display panel 100, the display panel driving circuit 110 and 120 may adjust a refresh frequency of the pixels 101 in conformity with frames per second (FPS) of the image under the control of the timing controller 130, thereby reducing a problem such as tearing or stuttering of the image that is reproduced on the screen of the display panel 100.

The pixels may charge a data voltage of pixel data in conformity with frames per second (FPS) that is varied in real time according to the variable refresh rate. The unit of the variable refresh rate may be hertz (Hz). When the refresh rate is about 60 Hz, pixel data may be written to the pixels for each frame period of about 60 frames per second, and when the refresh rate increases to about 120 Hz, pixel data is written to the pixels for each frame period of about 120 frames per second. In a display device in which the variable refresh rate is supported, a refresh frequency of the pixels at which pixel data may be written to the pixels changes according to the variable refresh rate.

The timing controller 130 may count the input timing signal (Vsync, HE, DE) by the clock to determine the refresh rate of the image in real time. The vertical synchronization signal Vsync may define one frame period. One pulse cycle of the horizontal synchronization signal and the Hsync and the data enable signal DE may be one horizontal period 1 H. The data enable signal DE may define a valid data interval in which pixel data of an image is present.

The display panel driving circuit 110 and 120 may reduce the power consumption of the display device by decreasing the refresh rate of the pixels 101 when a still image is input for a given time or more under the control of the timing controller 130 and may implement image quality as optimum image quality for contents of an image by increasing the refresh frequency of the pixels according to the refresh rate of the image. The refresh rate may be decreased when the display device operates in a standby mode or in response to a user's command. The refresh rate may be decreased on an Always On Display (AOD) screen. The AOD screen may be a partial pixel area of the display area AA where preset information, for example, brief information such as a remaining battery quantity and time is displayed in the standby mode.

The host system 200 may convert the resolution of an image signal from a video source in conformity with the resolution of the display panel 100 and may transmit the converted image signal to the timing controller 130 along with the timing signal.

A memory 132 may store driving setting timing information of the display panel driving circuit 110 and 120, program codes of a compensation algorithm for improving image quality, and the like. The memory 132 may include a nonvolatile memory and a volatile memory. The nonvolatile memory may include one or more of readable and writable memories, for example, a NAND flash memory, a NOR flash memory, and an electrically erasable programmable read-only memory (EEPROM). The NAND flash memory may be a single level cell (SLC) type. The volatile memory may include one or more of a dynamic RAM (DRAM), a static RAM (SRAM), a synchronous dynamic RAM (SDRAM), and a double data rate SDRAM (DDR SDRAM).

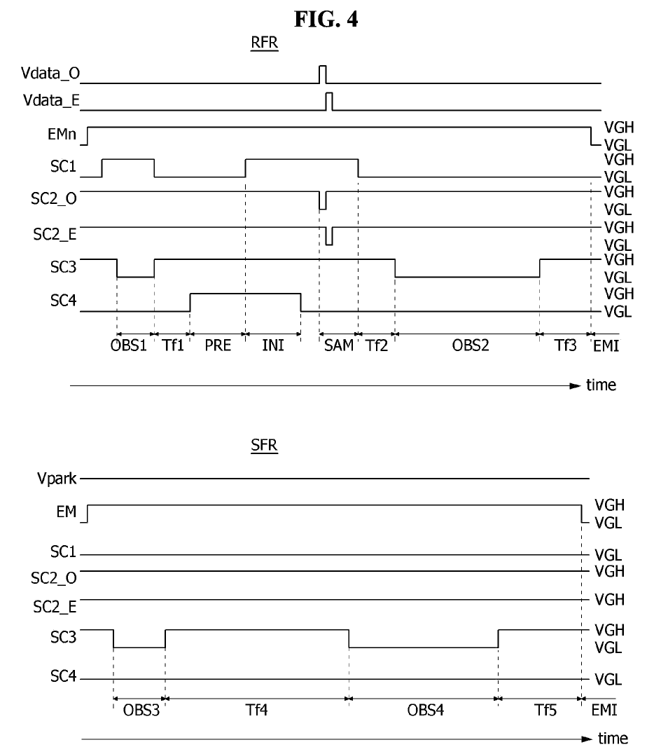

The display panel driving circuit 110 and 120 may drive the pixels at a high refresh rate or may drive the pixels at a low refresh rate under the control of the timing controller 130. The pixels may receive refresh driving signals as illustrated in FIG. 4 as input and may charge a data voltage of pixel data in a frame period during which the pixels are driven at the high refresh rate. The pixels may receive skip driving signals as illustrated in FIG. 4 as input and may maintain emission with a data voltage charged in a previous refresh period in a frame period during which the pixels are driven at the low refresh rate.

FIG. 3 is a schematic circuit diagram illustrating a pixel circuit according to the embodiment of the present disclosure. FIG. 4 is a schematic waveform chart illustrating driving signals that are applied to the pixel circuit illustrated in FIG. 3 in a refresh period and a skip period. In FIG. 4, a second scan signal SC2_O may be a gate signal that is applied to subpixels of an odd-numbered pixel line in synchronization with an odd-numbered data voltage Vdata_O. A second scan signal SC2_E may be a gate signal that is applied to subpixels of an even-numbered pixel line in synchronization with an even-numbered data voltage Vdata_E.

Referring to FIGS. 3 and 4, the pixel circuit may include a light-emitting element EL, a driving element DT that drives the light-emitting element EL, a plurality of switch elements M1 to M7, and a capacitor Cst.

Each of first and seventh switch elements M1 and M7 may be implemented as an n-channel oxide TFT. Each of the driving element DT and second, third, fourth, fifth, and sixth switch elements M2, M3, M4, M5, and M6 may be implemented as a p-channel LTPS TFT. The first and seventh switch elements M1 and M7 may be turned on in response to a gate high voltage VGH of a corresponding gate signal in FIG. 4, and may be turned off in response to a gate low voltage VGL of the corresponding gate signal. The second, third, fourth, fifth, and sixth switch elements M2, M3, M4, M5, and M6 may be turned on in response to a gate low voltage VGL of a corresponding gate signal in FIG. 4, and may be turned off in response to a gate high voltage VGH of the corresponding gate signal.

The pixel circuit may be electrically connected to a data line DL to which a data voltage Vdata of pixel data and a third compensation voltage Vpark are applied, and gate lines GL1, GL2, GL3, GL4, and GL5 to which the gate signals SC1, SC2, SC3, SC4, and EM are applied. The data voltage Vdata may be applied to the data line DL in a sampling period of a refresh period.

A pixel driving voltage ELVDD and a pixel ground voltage ELVSS may be set to voltages at which the driving element DT operates in a saturation region. The pixel driving voltage ELVDD may be set to a voltage of about 2 [V] to about 3 [V], and the pixel ground voltage ELVSS may be set to a voltage of about -8 [V] to about -10 [V], but embodiments of the present disclosure are not limited thereto. The gate high voltage VGH may be set to a voltage higher than the pixel driving voltage ELVDD, and the gate low voltage VGL may be set to a voltage lower than the pixel ground voltage ELVSS, but embodiments of the present disclosure are not limited thereto.

The data voltage Vdata may have a dynamic range of about 2 [V] to about 6 [V]. Within the dynamic range, a voltage level of the data voltage Vdata may be selected according to a grayscale value of pixel data. An initialization voltage Vinit may be set to a voltage lower than a lower limit voltage of the data voltage Vdata and higher than the pixel ground voltage ELVSS. For example, when the lower limit voltage of the data voltage Vdata is about 2 [V], and the pixel ground voltage ELVSS is about -9 [V], the initialization voltage Vinit may be set to a voltage of about -5 [V] to about -7 [V].

When the pixels 101 are driven at the variable refresh rate, to reduce a luminance difference between a refresh period and a skip period, a pixel compensation voltage may be applied to the pixel circuit. The pixel compensation voltage may include a first compensation voltage VOBS, a second compensation voltage VAR, and a third compensation voltage Vpark.

The second compensation voltage VAR may discharge the parasitic capacitance (Cel) of the light-emitting element (EL) to reset the anode voltage of the light-emitting element (EL). A luminance level of the pixels 101 at a low grayscale may be optimized by appropriately adjusting the anode voltage according to the second compensation voltage VAR. The second compensation voltage VAR may be varied. For example, when the dynamic range of the data voltage Vdata is about 2 [V] to about 6 [V], the second compensation voltage VAR may be varied in a range of about -4 [V] to about -5 [V] under the control of the timing controller 130.

The third compensation voltage Vpark may be set to a voltage for compensating for change in luminance of the pixels 101 between the refresh period and the skip period, and may be applied to the data lines DL during the skip period. The third compensation voltage Vpark may be set within a voltage range smaller than the dynamic range of the data voltage Vdata. For example, when the dynamic range of the data voltage Vdata is about 2 [V] to about 6 [V], the third compensation voltage Vpark may be set to a specific voltage of about 4 [V] to about 6 [V] or may be varied within this voltage range. The third compensation voltage Vpark may be output from the power supply 150 and may be applied to the data line DL via a separate switch element provided on the display panel 100 or a switch element of the data driver 110.

The gate signals SC1, SC2, SC3, SC4, and EM may include pulses that swing between the gate high voltage VGH and the gate low voltage VGL.

The driving element DT may include a gate electrode connected to a first node n1, a first electrode connected to a second node n2, and a second electrode connected to a third node n3. The capacitor Cst may be connected between a first power line PL1 to which the pixel driving voltage ELVDD is applied and the first node n1, and may suppress fluctuation of a gate-source voltage Vgs of the driving element DT.

The light-emitting element EL may include an anode electrode connected to a fourth node n4 and a cathode electrode connected to a second power line PL2 to which the pixel ground voltage ELVSS is applied. The light-emitting element EL may be implemented as an OLED. The OLED may include the parasitic capacitance Cel due to a stacked structure.

The first switch element M1 may be connected between the first node n1 and the third node n3, and may be turned on in response to the gate high voltage VGH of the first scan signal SC1. When the first switch element M1 is turned on, the first node n1 may be electrically connected to the third node n3. The second switch element M2 may be connected between the data line DL and the second node n2, and may be turned on in response to the gate low voltage VGL of the second scan signal SC2. When the second switch element M2 is turned on, the data line DL may be electrically connected to the second node n2.

The third switch element M3 may be connected between the first power line PL1 and the second node n2, and may be turned on in response to the gate low voltage VGL of the EM signal EM. When the third switch element M3 is turned on, the pixel driving voltage ELVDD may be applied to the second node n2. The fourth switch element M4 may be connected between the third node n3 and the fourth node n4, and may be turned on in response to the gate low voltage VGL of the EM signal EM. When the fourth switch element M4 is turned on, the third node n3 may be electrically connected to the fourth node n4.

The fifth switch element M5 may be connected between the second node n2 and a third power line PL3 to which the first compensation voltage VOBS is applied, and may be turned on in response to the gate low voltage VGL of the third scan signal SC3. When the fifth switch element M5 is turned on, the first compensation voltage VOBS may be applied to the second node n2. The sixth switch element M6 may be connected between the fourth node n4 and a fourth power line PL4 to which the second compensation voltage VAR is applied, and may be turned on in response to the gate low voltage VGL of the third scan signal SC3. When the sixth switch element M6 is turned on, the second compensation voltage VAR may be applied to the anode electrode of the light-emitting element EL connected to the fourth node n4.

At least one of the third power line PL3 and the fourth power line PL4 may be compensation voltage lines separated in units of one or more pixel lines. The compensation voltages having different voltage levels may be applied between pixel lines of pixels having different driving frequencies via the compensation voltage lines. For example, the voltage levels of the compensation voltages VOBS and VAR that are applied to a pixel line to be driven at a skip frequency may be higher or lower than the voltage levels of the compensation voltages VOBS and VAR that are applied to a pixel line to be driven at a refresh frequency. Accordingly, the voltage levels of the compensation voltages that reduce a luminance difference between pixel lines or sub-display areas having different pixel driving frequencies may be optimized in units of pixel line or between the sub-display areas.

The seventh switch element M7 may be connected between the first node n1 and a fifth power line PL5 to which the initialization voltage Vinit is applied, and may be turned on in response to the gate high voltage VGH of the fourth scan signal SC4. When the seventh switch element M7 is turned on, the initialization voltage Vinit may be applied to the capacitor Cst connected to the first node n1 and the gate electrode of the driving element DT.

The pixel circuit may receive the refresh driving signals as input, may be charged to the data voltage of the pixel data, and may be driven at the refresh frequency during the refresh period RFR. The refresh period RFR may be divided into a first on-bias period OBS1, a first initialization period PRE, a second initialization period INI, a sampling period SAM, a second on-bias period OBS2, and an emission period EMI.

A first floating period Tf1 may be set between the first on-bias period OBS1 and the first initialization period PRE. A second floating period Tf2 may be set between the sampling period SAM and the second on-bias period OBS2. A third floating period Tf3 may be set between the second on-bias period OBS2 and the emission period EMI. During the first, second, and third floating periods Tf1, Tf2, and Tf3, since all the first to seventh switch elements M1, M2, M3, M4, M5, M6, and M7 are in an off-state, the first to fourth nodesn1, n2, n3, and n4 may be brought into a floating state and maintained in previous state.

During the first on-bias period OBS1, the fifth and sixth switch elements M5 and M6 may be turned on, the first compensation voltage VOBS may be applied to the second node n2, and the second compensation voltage VAR may be applied to the fourth node n4. During the first on-bias period OBS1, the first switch element M1 may be turned on, and the first node n1 may be electrically connected to the third node n3.

During the first initialization period PRE, the seventh switch element M7 may be turned on, and the initialization voltage Vinit may be applied to the first node n1. During the first initialization period PRE, the light-emitting element EL may be in an off-state and may not emit light. During the second initialization period INI, the first and seventh switch elements M1 and M7 may be turned on, the initialization voltage Vinit may be applied to the first and third nodes n1 and n3, and the initialization voltage Vinit may be also applied to the second node n2 via the driving element DT that is maintained in an on-state.

During the sampling period SAM, the second switch element M2 may be turned on in response to the gate low voltage VGL of the second scan signal SC2. For example, the data voltage Vdata may be applied to the second node n2, and the data voltage Vdata may be applied to the first and third nodes n1 and n3 via the driving element DT in the on-state. During the second on-bias period OBS2, the fifth and sixth switch elements M5 and M6 may be turned on, the first compensation voltage VOBS may be applied to the second node n2, and the second compensation voltage VAR may be applied to the fourth node n4.

During the emission period EMI of the refresh period RFR, the third and fourth switch elements M3 and M4 may be turned on in response to the gate low voltage VGL of the EM signal EM. During the emission period EMI, a current path may be formed between the pixel driving voltage ELVDD and the light-emitting element EL via the third and fourth switch elements M3 and M4, and the light-emitting element EL may emit light with luminance corresponding to a grayscale value of pixel data.

The pixel circuit may receive the skip driving signals as input and may be driven at the skip frequency which is lower than the refresh frequency during the skip period SFR. The skip period SFR may be divided into a third on-bias period OBS3, a fourth on-bias period OBS4, and an emission period EMI. A fourth floating period Tf4 may be set between the third on-bias period OBS3 and the fourth on-bias period OBS4. A fifth floating period Tf5 may be set between the fourth on-bias period OBS4 and the emission period EMI. During the fourth and fifth floating periods Tf4 and Tf5, since all the first to seventh switch elements M1, M2, M3, M4, M5, M6, and M7 may be in the off-state, the first to fourth nodes n1, n2, n3, and n4 may be brought into the floating state.

The data driver 110 may not output the data voltage Vdata during the skip period SFR. During the skip period SFR, the third compensation voltage Vpark may be applied to the data lines DL. During the skip period SFR, the voltages of the first and fourth scan signals SC1 and SC4 may be maintained at the gate low voltage VGL, and the voltages of second scan signals SC2_O and SC2_E may be maintained at the gate high voltage VGH. During the skip period SFR, the first, second, and seventh switch elements M1, M2, and M7 may be maintained in the off-state. The gate driver 120 may not output the pulses of other scan signals SC1, SC2_O, SC2_E, and SC4 excluding the third scan signal SC3 during the skip period SFR. During the skip period SFR, the pixel circuit may be driven with the voltage of the capacitor Cst charged to the data voltage Vdata in a previous refresh period RFR and may cause the light-emitting element EL to emit light.

During the third and fourth on-bias periods OBS3 and OBS4, the fifth and sixth switch elements M5 and M6 may be turned on, the first compensation voltage VOBS may be applied to the second node n2, and the second compensation voltage VAR may be applied to the fourth node n4. During the third and fourth on-bias periods OBS3 and OBS4, the third scan signal SC3 may maintain the gate low voltage VGL.

During the emission period EMI of the skip period SFR, the third and fourth switch elements M3 and M4 may be turned on in response to the gate low voltage VGL of the EM signal EM. During the emission period EMI, a current path may be formed between the pixel driving voltage ELVDD and the light-emitting element EL via the third and fourth switch elements M3 and M4, and the light-emitting element EL may emit light with luminance corresponding to a grayscale value of pixel data.

During the skip period SFR, the pixels may be allowed to emit light with luminance corresponding to the grayscale of pixel data written previously. During the skip period SFR, the power consumption of the data driver 110 and the gate driver 120 may be substantially reduced. The skip frequency of the pixels 101 may be significantly smaller than the refresh frequency. Accordingly, when the pixels 101 are driven at the variable refresh rate, while an image is normally reproduced in the display panel 100, the power consumption of the display device may be reduced and the consumption of the voltage charged in the battery connected to the host system 200 may be reduced.

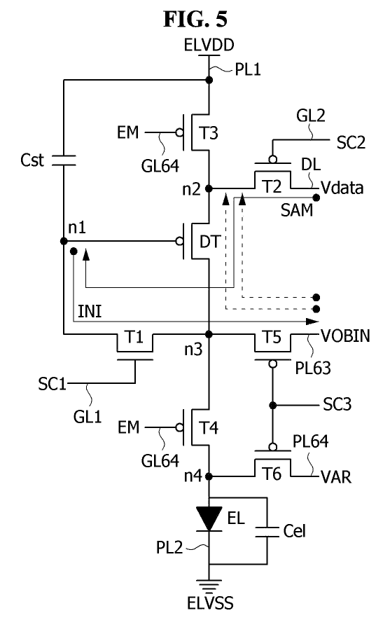

FIG. 5 is a schematic circuit diagram illustrating a pixel circuit according to another embodiment of the present disclosure. FIG. 6 is a schematic waveform chart illustrating driving signals that are applied to the pixel circuit illustrated in FIG. 5 in a refresh period and a skip period. Redundant description to the description of the above-described embodiment will not be repeated.

Referring to FIGS. 5 and 6, the pixel circuit may include a light-emitting element EL, a driving element DT that drives the light-emitting element EL, a plurality of switch elements T1 to T6, and a capacitor Cst. The pixel circuit may be connected to a data line DL, gate lines GL1, GL2, GL63, and GL64, and power lines PL1, PL2, PL63, and PL64.

A first switch element T1 may be implemented as an n-channel oxide TFT. Each of the driving element DT and second, third, fourth, fifth, and sixth switch elements T2, T3, T4, T5, and T6 may be implemented as a p-channel LTPS TFT. The first switch element T1 may be turned on in response to a gate high voltage VGH of a first scan signal SC1 and may be turned off in response to a gate low voltage VGL of the first scan signal SC1 in FIG. 6. The second, third, fourth, fifth, and sixth switch elements T2, T3, T4, T5, and T6 may be turned on in response to gate low voltages VGL of corresponding gate signals SC2, SC3, and EM and are turned off in response to gate high voltages VGH of the corresponding gate signals SC2, SC3, and EM in FIG. 6.

The first switch element T1 may be connected between a first node n1 and a third node n3, and may be turned on in response to the gate high voltage VGH of the first scan signal SC1 in an initialization period INI and a sampling period SAM of a refresh period RFR as illustrated in FIG. 6. When the first switch element T1 is turned on, the first node n1 may be electrically connected to the third node n3. The second switch element T2 may be connected between the data line DL and a second node n2, and may be turned on in response to the gate low voltage VGL of the second scan signal SC2 in the sampling period SAM of the refresh period RFR as illustrated in FIG. 6. When the second switch element T2 is turned on, the data line DL may be electrically connected to the second node n2.

The third switch element T3 may be connected between the first power line PL1 and the second node n2, and may be turned on in response to the gate low voltage VGL of the EM signal EM in an emission period EMI as illustrated in FIG. 6. When the third switch element T3 is turned on, the pixel driving voltage ELVDD may be applied to the second node n2. The fourth switch element T4 may be connected between the third node n3 and a fourth node n4, and may be turned on in response to the gate low voltage VGL of the EM signal EM in the emission period EMI as illustrated in FIG. 6. When the fourth switch element T4 is turned on, the third node n3 may be electrically connected to the fourth node n4.

The fifth switch element T5 may be connected between the third node n3 and a third power line PL63 to which a first compensation voltage VOBIN is applied, and may be turned on in response to the gate low voltage VGL of the third scan signal SC3. The first compensation voltage VOBIN may be an alternating-current voltage that swings between an on-bias voltage VOB and an initialization voltage VINI as illustrated in FIG. 6. The on-bias voltage VOB may be a voltage higher than the initialization voltage VINI. The on-bias voltage VOB may be applied to the third node n3 via the fifth switch element T5 during on-bias periods OBS1, OBS2, OBS3, and OBS4. The initialization voltage VINI may be applied to the third node n3 via the fifth switch element T5 during the initialization period INI. The on-bias voltage VOB may correspond to the first compensation voltage VOBS in the above-described embodiment, and the initialization voltage VINI may correspond to the initialization voltage Vinit in the above-described embodiment.

The sixth switch element T6 may be connected between the fourth node n4 and a fourth power line PL64, and may be turned on in response to the gate low voltage VGL of the third scan signal SC3. The second compensation voltage VAR may be applied to the fourth node n4 via the sixth switch element T6 during the on-bias periods OBS1, OBS2, OBS3, and OBS4.

In the above-described pixel circuits, the switch elements M1 and M7 and the switch element T1 connected to the capacitor Cst may be implemented as an n-channel oxide TFT having less leakage current, thereby decreasing a leakage current.

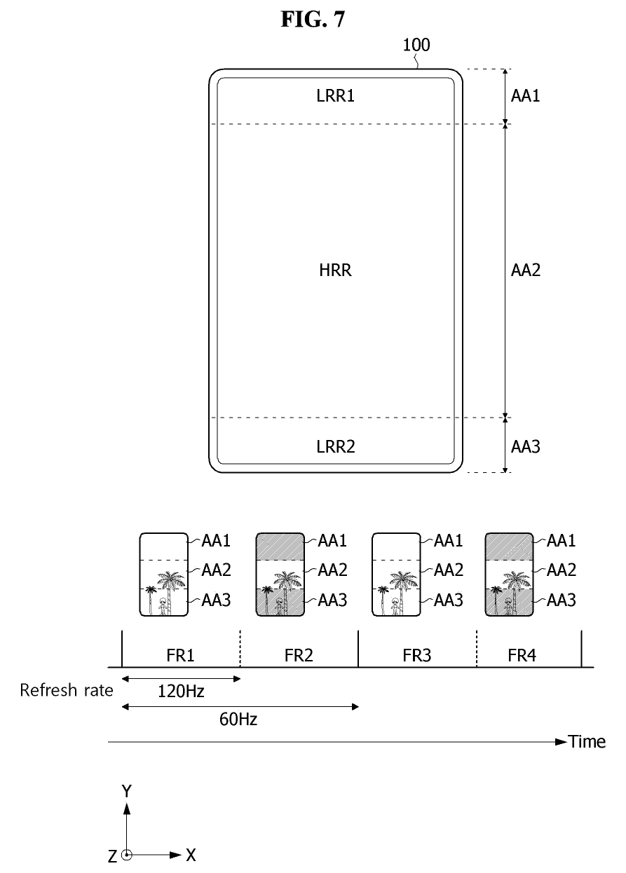

FIG. 7 is a schematic diagram illustrating an example of a display panel that is driven at multiple frequencies in one frame period.

Referring to FIG. 7, a display area AA of the display panel 100 may be divided into multiple sub-display areas AA1, AA2, and AA3 and may reproduce an image at different refresh rates in one frame period. In the display panel 100, the sub-display areas AA1, AA2, and AA3 may mean local pixel areas which are not physically separated and in which driving frequencies of pixels are controlled independently according to the refresh rates. The sub-display areas AA1, AA2, and AA3 may include pixels and signal wires having substantially the same structures. When the pixels of the sub-display areas AA1, AA2, and AA3 are driven at a variable refresh rate, the sub-display areas AA1, AA2, and AA3 may be local areas having the pixels with different driving frequencies in the display area AA. One frame image may be visually reproduced in one frame period in the display area AA. For example, a first portion of the one frame image may be displayed in a first sub-display area AA1, a second portion of the one frame image may be displayed in a second sub-display area AA2, and a third portion of the one frame image may be displayed in a third sub-display area AA3, simultaneously.

The timing controller 130 may control each of the sub-display areas AA1, AA2, and AA3 as a refresh area or a skip area. The timing controller 130 may determine a refresh rate of an image in real time and may vary the size and position of each of the sub-display areas AA1, AA2, and AA3 for each frame period. Part of an upper end and a lower end of the image may be reproduced in the first and third sub-display areas AA1 and AA3 at a first low refresh rate LRR1 and a second low refresh rate LRR2, for example, about 60 Hz. A central portion of the image may be reproduced in the second sub-display area AA2 at a high refresh rate HRR, for example, about 120 Hz. The refresh rates of the first sub-display area AA1 and the third sub-display area AA3 may be the same or different from each other.

In the example of FIG. 7, the pixels in the first sub-display area AA1 may be driven at a refresh frequency during first and third frame periods FR1 and FR3, and may be driven at a skip frequency during second and fourth frame periods FR2 and FR4. The refresh frequency may be a pixel driving frequency at which a data voltage is charged in the pixels and pixel data is updated. The skip frequency may be a pixel driving frequency at which an update cycle of the pixels is decreased due to a skip period. The pixels in the second sub-display area AA2 may be driven at the refresh frequency during each of the first to fourth frame periods FR1, FR2, FR3, and FR4.

When the pixels 101 are driven at the variable refresh rate, a threshold voltage Vth of the driving element DT may be changed between the refresh period RFR and the skip period SFR. For this reason, the luminance of the pixels 101 may be made different between the refresh period RFR and the skip period SFR.

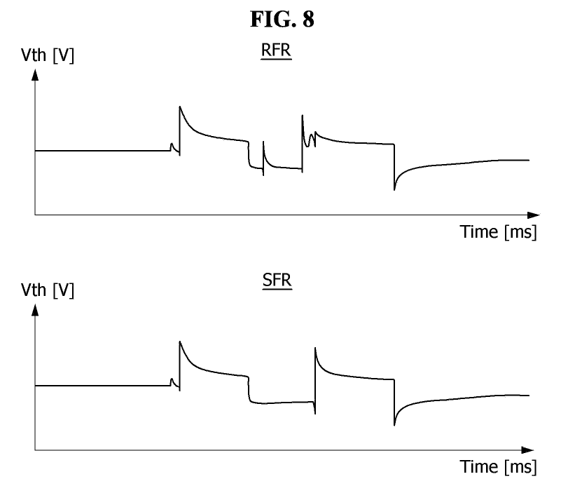

FIG. 8 is a schematic simulation result illustrating the threshold voltage of the driving element DT for refresh driving and skip driving of the pixel circuit illustrated in FIG. 3. In FIG. 8, the horizontal axis may represent time, and the vertical axis may represent a threshold voltage Vth of a driving element. The threshold voltage Vth of the driving element DT may fluctuate according to the gate-source voltage Vgs. A current for driving the light-emitting element EL may be made different according to the threshold voltage Vth of the driving element DT. As will be understood from FIG. 8, when the pixel circuit is driven by skip driving, since initialization and a step in which pixel data is written are not performed, during skip driving, fluctuation of the threshold voltage Vth of the driving element DT may be smaller than that during refresh driving. For this reason, the current for driving the light-emitting element EL may be different between refresh driving and skip driving. This may cause a luminance difference between the pixel 101 that is driven by refresh driving and the pixel 101 that is driven by skip driving.

The first compensation voltage VOBS and/or the second compensation voltage VAR that are applied to the pixels may be separated into optimum voltages according to the pixel driving frequency, thereby reducing a luminance difference between sub-display areas with different refresh rate on the same screen. When the voltage level of the first compensation voltage VOBS is made different, the threshold voltage Vth of the driving element DT may be made different. The voltage level of the first compensation voltage VOBS may be controlled to be different according to the pixel driving frequency to cause a difference in fluctuation of the threshold voltage Vth of the driving element DT between sub-display areas with different refresh rates, thereby minimizing an average luminance difference between sub-display areas with different refresh rates.

For example, the first compensation voltage VOBS that is applied to the pixels to be driven by skip driving may be decreased to be lower than the first compensation voltage VOBS that is applied to the pixels to be driven by refresh driving, thereby increasing luminance of a sub-display area to be driven at a low refresh rate to a luminance level of a sub-display area to be driven at a high refresh rate. On the contrary, when luminance of a sub-display area to be driven at a low refresh rate needs to be decreased in conformity with the luminance of the screen to be driven at a high refresh rate, the first compensation voltage VOBS that is applied to the pixels to be driven by skip driving increases to be higher than the first compensation voltage VOBS that is applied to the pixels to be driven by refresh driving, thereby adjusting the luminance of the sub-display area to be driven at the low refresh rate.

When there is a large difference in voltage level of the first compensation voltage VOBS and/or the second compensation voltage VAR optimized according to the pixel driving frequency, a luminance difference may be visually recognized between sub-display areas with different refresh rates. A luminance difference between the sub-display areas can be minimized by gradually changing the first compensation voltage VOBS and/or the second compensation voltage VAR between the sub-display areas with different refresh rates.

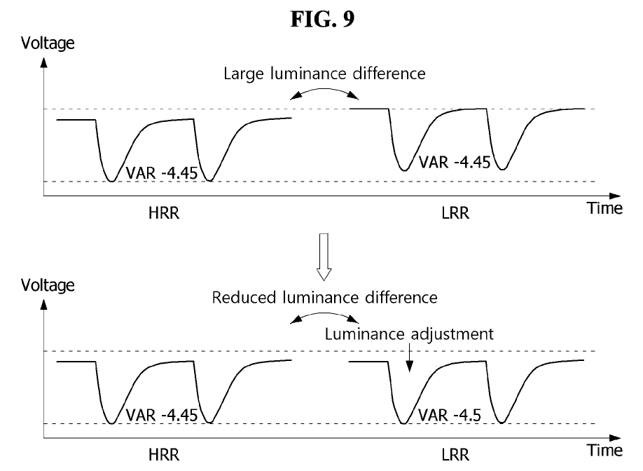

FIG. 9 is a schematic diagram illustrating an example where a luminance difference between display areas with different refresh rates is reduced by decreasing a second compensation voltage to be applied to a sub-display area with a low refresh rate lower than a second compensation voltage to be applied to a sub-display area with a high refresh rate.

FIG. 9 illustrates an example where the second compensation voltage VAR that is applied to a sub-display area with a low refresh rate LRR is decreased to be lower than the second compensation voltage VAR that is applied to a sub-display area with a high refresh rate HRR, thereby reducing a luminance difference between display areas with different refresh rates. The second compensation voltage VAR may set an initial voltage that is charged in the parasitic capacitance Cel of the light-emitting element EL. The initial voltage that is charged in the parasitic capacitance Cel of the light-emitting element EL may be made different according to the second compensation voltage VAR. When the voltage level of the second compensation voltage VAR is appropriately adjusted, an initial luminance level and a peak luminance level of the light-emitting element EL may be influenced, thereby reducing a luminance difference of pixels with different driving frequencies according to the variable refresh rate.

FIGS. 10, 11, 12, and 13, are schematic waveform charts illustrating a control method of pixel compensation voltages according to various embodiments of the present disclosure. In FIGS. 10, 11, 12, and 13, LRR1 may denote a low refresh rate of a first sub-display area, and HRR may denote a high refresh rate of a second sub-display area. The low refresh rate and the high refresh rate may be a relative concept. The high refresh rate HRR may be a refresh rate higher than the low refresh rate LRR1. In the description of FIGS. 10, 11, 12, and 13, redundant description will not be repeated.

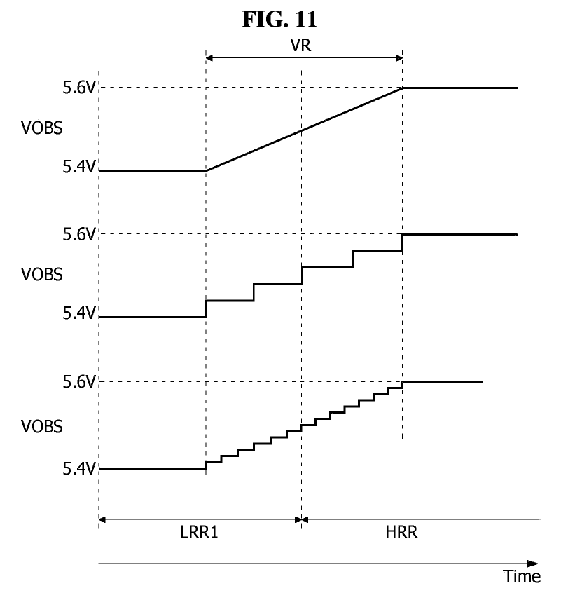

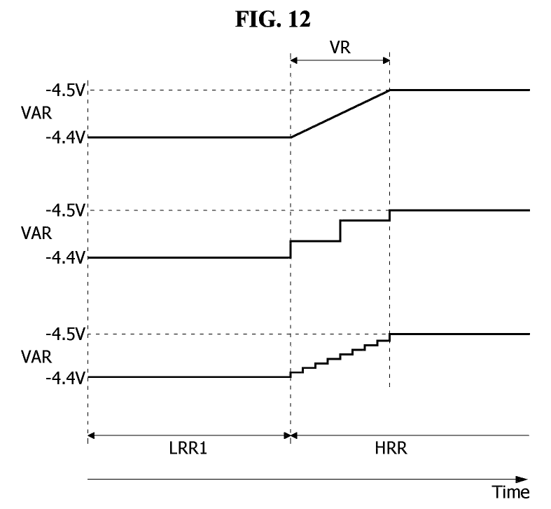

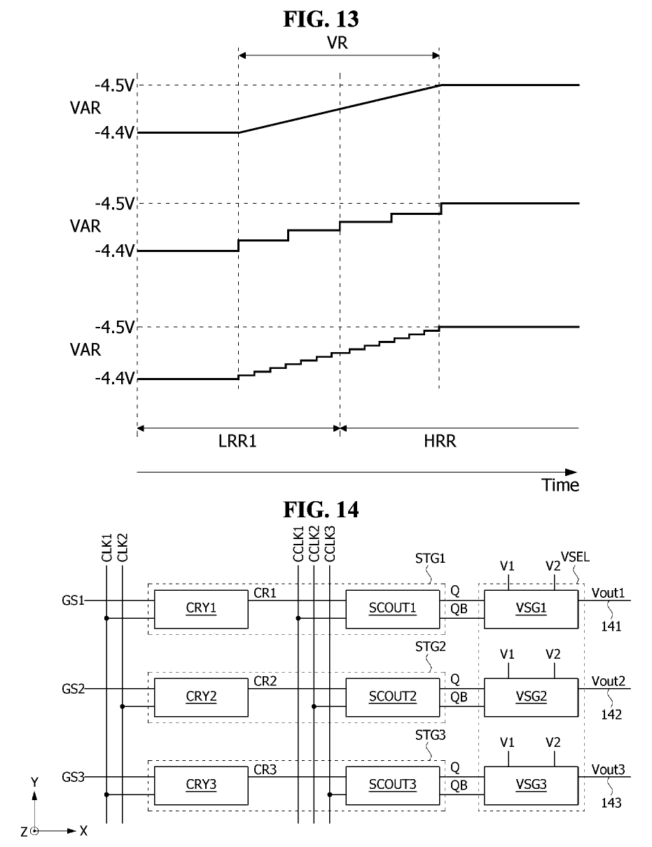

In FIGS. 10, 11, 12, and 13, optimum voltage levels of the first compensation voltage VOBS and the second compensation voltage VAR capable of reducing an average luminance difference between the first sub-display area and the second sub-display area with different refresh rates may be set to be different according to the refresh rates. The first compensation voltage VOBS or the second compensation voltage VAR that is applied to the first sub-display area may be set to a first voltage. The first compensation voltage VOBS or the second compensation voltage VAR that is applied to the second sub-display area may be set to a second voltage. In FIGS. 10 and 11, the first voltage of the first compensation voltage VOBS may be about 5.4 V, and the second voltage of the first compensation voltage VOBS may be about 5.5 V. However, these are merely illustrative, and embodiments of the present disclosure are not limited thereto. The first voltage of the first compensation voltage VOBS may be a voltage higher than the second voltage of the first compensation voltage VOBS. In FIGS. 12 and 13, the first voltage of the second compensation voltage VAR is about -4.4 V, and the second voltage of the second compensation voltage VAR is about -4.5 V, but embodiments of the present disclosure are not limited thereto. The first voltage of the second compensation voltage VAR may be a voltage higher than the second voltage of the second compensation voltage VAR.

Referring to FIG. 10, a voltage variable interval VR may be set from a boundary line (a dotted line along the vertical axis) between the first sub-display area and the second sub-display area to an i-th (where i is a natural number equal to or greater than four) pixel line of the second sub-display area. The first compensation voltage VOBS may be applied as a first voltage level to pixels in the first sub-display area. The first compensation voltage VOBS may be applied as a second voltage level to pixels in the second sub-display area. The voltage variable interval VR may be the voltage variable interval VR having a size including four or more pixel lines, for example, a first pixel line of the second sub-display area to the i-th pixel line of the second sub-display area.

In the second sub-display area, the first compensation voltage VOBS may be applied as a voltage between the first voltage and the second voltage to the first pixel line of the second sub-display area and may gradually increase or decrease. For example, the first compensation voltage VOBS may be linearly or gradually changed from the first voltage to the second voltage during the on-bias period OBS of pixel lines that include a predetermined number of pixel lines from the first pixel line of the second sub-display area and are shifted along a scanning direction. As an example, when the voltage level of the first compensation voltage VOBS is changed in a stepwise form, the first compensation voltage VOBS may be changed in units of horizontal period. After the voltage variable interval VR ends, in a voltage fixed interval of the second sub-display area, the first compensation voltage VOBS may be applied as the second voltage in the on-bias period OBS of the remaining pixel lines of the second sub-display area along the scanning direction. The on-bias period OBS may be first on-bias period OBS1 and OBS3 or second on-bias periods OBS2 and OBS4 of the first and second sub-display areas.

The first compensation voltage VOBS may be gradually changed from the first voltage to the second voltage, for example, in units of one to eight horizontal periods in the on-bias periods OBS of the pixel lines that include a predetermined number of pixel lines, for example, four to sixteen pixel lines from the first pixel line of the second sub-display area and are shifted along the scanning direction.

Referring to FIG. 11, the voltage level of the first compensation voltage VOBS may gradually increase or decrease within a voltage variable interval VR having a predetermined size centering on a boundary line (a dotted line in the vertical axis direction) between the first sub-display area and the second sub-display area. A pixel line of the first sub-display area may be positioned at an end on one side of the voltage variable interval VR. A pixel line of the second sub-display area may be positioned at an end of the other side of the voltage variable interval VR. For example, the first voltage of the first compensation voltage VOBS may be sequentially applied to the pixel lines of the first sub-display area, for example, from the first pixel line of the first sub-display area to a pixel line before the end on one side of the voltage variable interval VR. Subsequently, the voltage level of the first compensation voltage VOBS may gradually increase or decrease from the pixel line positioned at the end of one side of the voltage variable interval VR in the first sub-display area to the pixel line positioned at the end of the other side of the voltage variable interval VR in the second sub-display area and reach the second voltage. Then, the first compensation voltage VOBS may be applied as the second voltage to the remaining pixel lines of the second sub-display area.

Referring to FIG. 12, the second compensation voltage VAR that is applied to the pixel lines of the second sub-display area adjacent to the boundary line (a dotted line along the vertical axis) between the first sub-display area and the second sub-display area may gradually increase or decrease from a first pixel area of the second sub-display area positioned on the boundary line. For example, the second compensation voltage VAR may be changed linearly or gradually from the first voltage to the second voltage in the on-bias periods OBS of pixel lines that include a predetermined number of pixel lines from the first pixel line of the second sub-display area and are shifted along the scanning direction. When the voltage level of the second compensation voltage VAR is changed in a stepwise form, the second compensation voltage VAR may be changed in units of horizontal period. Subsequently, the second compensation voltage VAR may be applied as the second voltage to the pixels in the on-bias periods OBS of the remaining pixel lines of the second sub-display area along the scanning direction.

The second compensation voltage VAR that is applied to the pixel lines of the second sub-display area adjacent to the boundary between the first sub-display area and the second sub-display area may gradually increase or decrease. For example, the second compensation voltage VAR may be changed from the first voltage to the second voltage gradually, for example, in units of one horizontal period or in units of n (where n is a natural number of two to eight) horizontal periods in the on-bias periods OBS of pixel lines that include a predetermined number of pixel lines from the first pixel line of the second sub-display area, for example, four to sixteen pixel lines and are shifted along the scanning direction.

Referring to FIG. 13, the voltage level of the second compensation voltage VAR may gradually increase or decrease within a voltage variable interval VR between the first sub-display area and the second sub-display area. For example, the first voltage of the second compensation voltage VAR may be sequentially applied to the pixel lines of the first sub-display area from the first pixel line to a pixel line before an end of one end of the voltage variable interval VR in the first sub-display area. Subsequently, the voltage level of the second compensation voltage VAR may gradually increase or decrease from a pixel line at the end on one side of the voltage variable interval VR in the first sub-display area to a pixel line positioned at an end of the other side of the voltage variable interval VR in the second sub-display area and reaches the second voltage, and then, the second compensation voltage VAR is applied as the second voltage to the remaining pixel lines of the second sub-display area.

In FIGS. 10, 11, 12, and 13, the voltage variable interval VR may be controlled by the timing controller 130. The timing controller 130 may apply the voltage control data VCD to the power supply 150 and may control voltages that are output from the power supply 150. For example, the timing controller 130 may control one or more of the timing of the voltage variable interval VR, a voltage inclination, a voltage fluctuation cycle, a voltage fluctuation width, and the like in conformity with the refresh rate of the image.

The voltage inclination may be decreased by making the voltage variable interval VR large such that the luminance difference at the boundary between the sub-display areas is prevented from becoming greater as the difference in refresh rate between the sub-display areas is greater. For example, in FIGS. 10, 11, 12, and 13, when LRR1 is equal to about 1 [Hz] and HRR is equal to about 60 [Hz], the voltage variable interval VR may be set to a size as in FIGS. 10 and 12. When a difference in refresh rate between the sub-display areas becomes large than LRR1 which is equal to about 1 [Hz] and HRR which is equal to about 120 [Hz], the voltage variable interval VR may become greater as in FIGS. 11 and 13.

In FIG. 7, each of the sub-display areas AA1, AA2, and AA3 may include compensation voltage lines formed along the X-axis direction parallel to the gate line. The compensation voltage lines may be separated between adjacent pixel lines. The voltage selection circuit of the gate driver may select the voltage level of the compensation voltage to be applied to the compensation voltage line to an optimum voltage level according to the pixel driving frequency and may apply the compensation voltage by pixel line.

FIG. 14 is a schematic block diagram illustrating a voltage selection circuit according to the embodiment of the present disclosure. FIG. 15 is a schematic circuit diagram illustrating an example of a voltage selector illustrated in FIG. 14.

Referring to FIGS. 14 and 15, the voltage selection circuit of the gate driver 120 may include a plurality of control signal transmitters STG1, STG2, and STG3 and a voltage selector VSEL.

The control signal transmitters STG1, STG2, and STG3 may include a plurality of carry signal transmitters CRY1, CRY2, and CRY3, and a plurality of control signal output parts SCOUT1, SCOUT2 and SCOUT3 that output first and second control signals Q and QB, respectively.

The carry signal transmitters CRY1, CRY2, and CRY3 may receive, as input, selected gate signals GS1, GS2, and GS3, respectively, and may also receive, as input, clock CLK1 or CLK2 from the timing controller 130 via the level shifter 140. The gate signals GS1, GS2, and GS3 may output from another gate driver and sequentially shifted in units of pixel line, for example, an EM signal or a separate gate signal. The carry signal transmitters CRY1, CRY2, and CRY3 may output carry signals CR1, CR2, and CR3 under the control of the timing controller 130, respectively.

The control signal transmitters STG1, STG2, and STG3 may receive, as input, the carry signals CR1, CR2, and CR3 and clocks CCLK1, CCLK2, and CCLK3, respectively, and may output the first and second control signals Q and QB. The timing controller 130 may appropriately control the timings of the voltage variable interval of the pixel compensation voltage VOBS or VAR between the pixel lines or the sub-display areas having different driving frequencies according to the refresh rate of the image by controlling the timings of the clocks CCLK1, CCLK2, and CCLK3.

The voltage selector VSEL may include a plurality of voltage output parts VSG1, VSG2, and VSG3. The voltage output parts VSG1, VSG2, and VSG3 may select first and second voltage V1 and V2 and output the selected voltage as the pixel compensation voltage VOBS and VAR in response to the first and second control signals Q and QB received from the corresponding control signal transmitters STG1, STG2, and STG3.

The voltage output parts VSG1, VSG2, and VSG3 may receive, as input, the first and second voltages V1 and V2 having different voltage levels from the power supply 150, and output the pixel compensation voltage VOBS or VAR to the corresponding compensation voltage lines 141, 142, and 143. The timing controller 130 may accurately control the voltage variable interval VR and a voltage variable form of each of the first and second voltages V1 and V2 in units of horizontal period or in units of pixel line as illustrated in FIGS. 10, 11, 12, and 13, by controlling the power supply 150.

The compensation voltage lines 141, 142, and 143 supply the pixel compensation voltage VOBS or VAR to different pixel lines. For example, a first compensation voltage line 141 may be electrically connected to subpixels of a first pixel line. A second compensation voltage line 142 may be electrically connected to subpixels of an M-th (where M is a natural number equal to or greater than two) pixel line. A third compensation voltage line 143 may be electrically connected to subpixels of an N-th (where N is a natural number equal to or greater than three) pixel line. Each of the compensation voltage lines 141, 142, and 143 may be electrically connected to one or more pixel lines.

Each of the voltage output parts VSG1, VSG2, and VSG3 may include first and second transistors VT1 and VT2 as illustrated in FIG. 15.

A first transistor VT1 may be connected between a first voltage node to which the first voltage V1 is applied and corresponding one of the compensation voltage lines 141, 142, and 143, and may be turned on in response to the first control signal Q. When the first transistor VT1 is turned on, the pixel compensation voltage VOBS or VAR may be output as the first voltage V1. The first voltage V1 may increases or decrease in the voltage variable interval VR and may be maintained at the first voltage level in the voltage interval as illustrated in FIGS. 10, 11, 12, and 13. The first transistor VT1 may include a gate electrode connected to a first control node to which the first control signal Q is applied, a first electrode connected to the first voltage node, and a second electrode connected to corresponding one of the compensation voltage lines 141, 142, and 143. A capacitor VC may be connected between the first voltage node and the first control node.

A second transistor VT2 may be connected between a second voltage node to which the second voltage V2 is applied and corresponding one of the compensation voltage lines 141, 142, and 143, and may be turned on in response to the second control signal QB. When the second transistor VT2 is turned on, the pixel compensation voltage VOBS or VAR is output as the second voltage V2. The second voltage V2 may increase or decrease in the voltage variable interval VR and may be maintained at the second voltage level in the voltage interval as illustrated in FIGS. 10, 11, 12, and 13. The second transistor VT2 may include a gate electrode connected to a second control node to which the second control signal QB is applied, a first electrode connected to the second voltage node, and a second electrode connected to corresponding one of the compensation voltage lines 141, 142, and 143.

As described above, the voltage levels of the first compensation voltage VOBS and/or the second compensation voltage VAR may be adjusted according to the pixel driving frequency, thereby reducing the luminance difference between the sub-display areas AA1, AA2, and AA3 with different refresh rates.

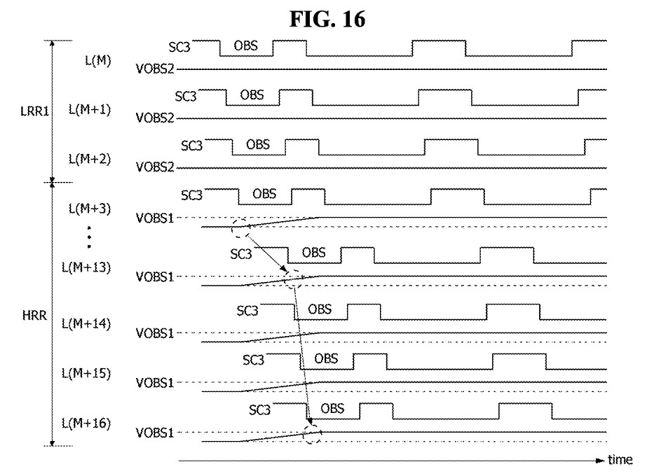

FIGS. 16, 17, 18, 19, 20, 21, and 22 are waveform charts illustrating various embodiments in which compensation voltages are differentially applied to sub-display areas with different refresh rates to perform luminance adjustment between the sub-display areas. In FIGS. 16, 17, 18, 19, 20, 21, and 22, LRR1 and LRR2 denote the low refresh rates of the first and third sub-display areas AA1 and AA3 illustrated in FIG. 7, and HRR denotes the high refresh rate of the second sub-display area AA2 illustrated in FIG. 7. In FIGS. 16, 17, 18, 19, 20, 21, and 22, redundant description will not be repeated.

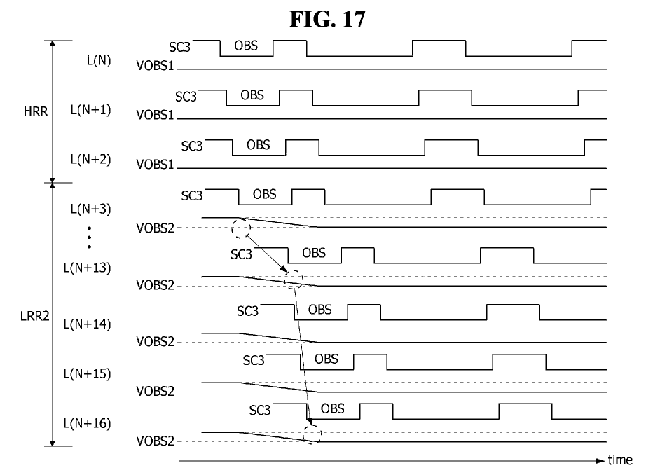

Referring to FIGS. 16 and 17, the first compensation voltage VOBS may be applied as a VOBS2 level to pixel lines L(M) to L(M+2) of the first sub-display area AA1 along the on-bias periods OBS that are sequentially shifted in the pixel lines L(M) to L(M+2). The first compensation voltage VOBS that is applied to the first sub-display area AA1 may be applied to the pixels via the compensation voltage lines provided in the first sub-display area AA1. The compensation voltage lines may be separated in units of one or more pixel lines, and are separated between the sub-display areas AA1, AA2, and AA3. For example, when the first compensation voltage that is applied to the compensation voltage lines in the voltage variable interval between adjacent sub-display areas AA1, AA2, and AA3 with different refresh rates is changed, the first compensation voltage that is applied to the compensation voltage lines of other pixel lines may be maintained without being influenced by the change of the first compensation voltage. A VOBS1 level may be a voltage higher than the VOBS2 level, but is not limited thereto.

The first compensation voltage VOBS may be applied as a VOBS1 level to pixel lines L(M+3) to L(N+2) of the second sub-display area AA2 along the on-bias periods OBS that are sequentially shifted in the pixel lines L(M+3) to L(N+2). The first compensation voltage VOBS that is applied to the second sub-display area AA2 may be applied to the pixels via the compensation voltage lines provided in the second sub-display area AA2. The first compensation voltage VOBS may be applied as the VOBS2 level to the pixel lines L(N+3) to L(N+16) of the third sub-display area AA3 along the on-bias periods OBS that are sequentially shifted in the pixel lines L(N+3) to L(N+16). The first compensation voltage VOBS that is applied to the third sub-display area AA3 may be applied to the pixels via the compensation voltage lines provided in the third sub-display area AA3.

When the first compensation voltage VOBS is rapidly changed at the boundary between the sub-display areas AA1, AA2, and AA3, a luminance difference may be visually recognized on the boundary line between adjacent sub-display areas AA1, AA2, and AA3. To prevent the luminance difference from being visually recognized, the voltage level of the first compensation voltage VOBS may be gradually changed in the voltage variable interval between adjacent sub-display areas AA1, AA2, and AA3. For example, as illustrated in FIG. 16, the first compensation voltage VOBS may start to be applied as a voltage higher than VOBS2 and lower than VOBS1 in the first pixel line L(M+3) of the second sub-display area AA2 where the voltage variable interval starts, then, gradually increases along the on-bias periods OBS that are shifted along the scanning direction, and reaches the VOBS1 level in the (M+16)th pixel line L(M+16) where the voltage variable interval ends. Subsequently, as illustrated in FIG. 17, the first compensation voltage VOBS may be maintained at the VOBS1 level until the (N+2)th pixel line L(N+2) where the second sub-display area AA2 ends.

Subsequently, the first compensation voltage VOBS may start to be applied as a voltage lower than VOBS1 and higher than VOBS2 in the (N+3)th pixel line L(N+3) where the voltage variable interval starts in the third sub-display area AA3, then, gradually may decrease along the on-bias periods OBS that are shifted along the scanning direction, and reach the VOBS2 level in the (N+16)th pixel line L(N+16) where the voltage variable interval ends. Subsequently, the first compensation voltage VOBS may be applied as the VOBS2 level to the pixel lines of the third sub-display area AA3 until the end of the third sub-display area AA3.

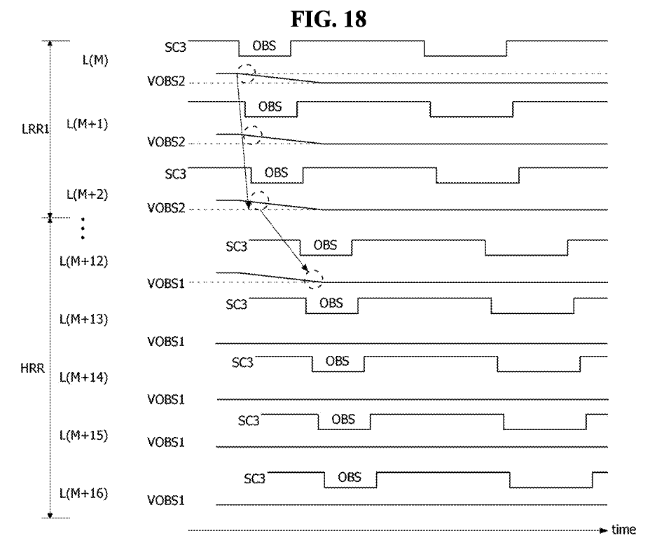

Referring to FIG. 18, the first compensation voltage VOBS may be applied as the VOBS2 level along the on-bias periods OBS of the pixel lines of the first sub-display area AA1, and then, may be decreased to a voltage lower than VOBS2 level and higher than the VOBS1 level from the on-bias period OBS of the (M+1)th pixel line L(M+1) where the voltage variable interval starts. Subsequently, the first compensation voltage VOBS may gradually decrease until the (M+12)th pixel line L(M+12) of the second sub-display area AA2 where the voltage variable interval ends, and then, reach the VOBS1 level in the on-bias period OBS of the (M+13)th pixel line L(M+13). Subsequently, the first compensation voltage VOBS may be applied as the VOBS1 level to the remaining pixel lines from the (M+13)th pixel line L(M+13) in the second sub-display area AA2.

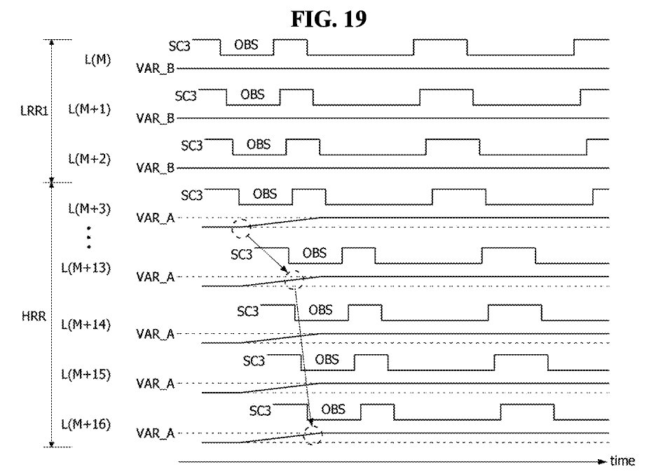

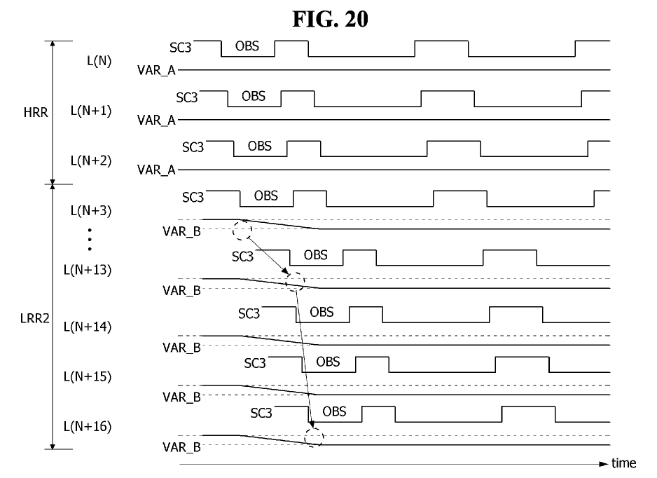

Referring to FIGS. 19 and 20, the second compensation voltage VAR may be applied as a VAR_B level to the pixel lines L(M) to L(M+2) of the first sub-display area AA1 along the on-bias periods OBS that are sequentially shifted in the pixel lines L(M) to L(M+2). The second compensation voltage VAR that is applied to the first sub-display area AA1 may be applied to the pixels via the compensation voltage lines provided in the first sub-display area AA1. The VAR_B level may be a voltage lower than a VAR_A level, but is not limited thereto. The second compensation voltage VAR may be applied as the VAR_A level to the pixel lines L(M+3) to L(N+2) of the second sub-display area AA2 along the on-bias periods OBS that are sequentially shifted in the pixel lines L(M+3) to L(N+2). The second compensation voltage VAR that is applied to the second sub-display area AA2 may be applied to the pixels via the compensation voltage lines provided in the second sub-display area AA2. The first compensation voltage VOBS may be applied as the VOBS2 level to the pixel lines L(N+3) to L(N+16) of the third sub-display area AA3 along the on-bias periods OBS that are sequentially shifted in the pixel lines L(N+3) to L(N+16). The first compensation voltage VOBS that is applied to the third sub-display area AA3 may be applied to the pixels via the compensation voltage lines provided in the third sub-display area AA3.

When the second compensation voltage VAR is rapidly changed at the boundary between adjacent sub-display areas AA1, AA2, and AA3 with different refresh rates, a luminance difference may be visually recognized on the boundary line between adjacent sub-display areas AA1, AA2, and AA3. To prevent the luminance different from being visually recognized, the voltage level of the second compensation voltage VAR may be gradually changed in the voltage variable interval between adjacent sub-display areas AA1, AA2, and AA3. For example, as illustrated in FIG. 19, the second compensation voltage VAR may start to be applied as a voltage higher than VAR_B and lower than VAR_A in the first pixel line L(M+3) of the second sub-display area AA2 where the voltage variable interval starts, then, gradually increases along the on-bias periods OBS that are shifted along the scanning direction, and reaches the VAR_A level in the (M+16)th pixel line L(M+16) where the voltage variable interval ends. Subsequently, as illustrated in FIG. 20, the second compensation voltage VAR may be maintained at the VAR_A level until the (N+2)th pixel line L(N+2) where the second sub-display area AA2 ends.

Subsequently, the second compensation voltage VAR may start to be applied as a voltage lower than VAR_A and higher than VAR_B in the (N+3)th pixel line L(N+3) where the voltage variable interval starts in the third sub-display area AA3, may gradually decrease along the on-bias periods OBS that are shifted along the scanning direction, and reach the VAR_B level in the (N+16)th pixel line L(N+16) where the voltage variable interval ends. Subsequently, the second compensation voltage VAR may be applied as the VAR_B level to the pixel lines of the third sub-display area AA3 until the end of the third sub-display area AA3.

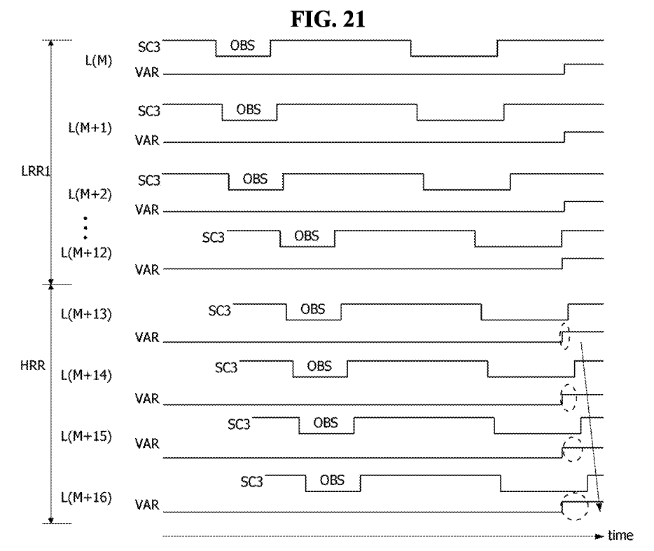

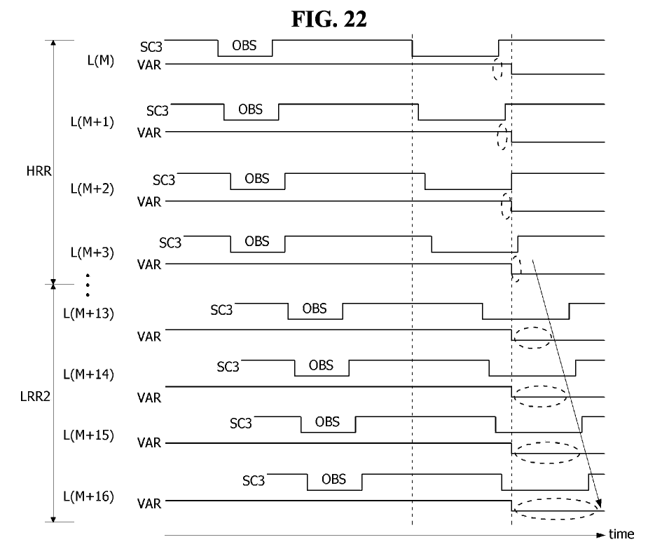

A single compensation voltage that is output from the power supply 150 may be applied in common to the sub-display areas AA1, AA2, and AA3 with different refresh rates, and the voltage level of the compensation voltage may be varied. As an example, as illustrated in FIGS. 21 and 22, the second compensation voltage VAR may be applied to the sub-display areas AA1, AA2, and AA3, and the influence of the compensation voltage may be gradually increased or decreased in a boundary area between sub-display areas where the pixel driving frequency is changed along the on-bias periods OBS that are sequentially shifted.

In FIGS. 21 and 22, a size of a dotted-line circle may indicate that a charge amount of the parasitic capacitance of the light-emitting element EL is gradually increased or decreased in the pixel lines of the boundary area between the sub-display areas where the pixel driving frequency is changed. When the pixel driving frequency is increased from the skip frequency to the refresh frequency or when the pixel driving frequency is decreased conversely, the charge amount of the parasitic capacitance of the light-emitting element EL may be made different according to a correlation relationship between the on-bias periods OBS defined by the third scan signal SC3 and a point of time at which the voltage level of the second compensation voltage VAR is changed. As an example, when the second compensation voltage VAR increases earlier before the on-bias periods OBS ends, the charge amount of the parasitic capacitance of the light-emitting element EL may increase, and the degree of influence of the second compensation voltage VAR may become greater.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display device according to one or more embodiments of the present disclosure may be applied to organic light emitting lighting devices or inorganic light emitting lighting devices.

According to one or more embodiments of the present disclosure, it is possible to reduce power consumption by decreasing a refresh rate without causing deterioration of image quality of an image, and to reduce a luminance difference between adjacent sub-display areas with different refresh rates by optimizing the voltage level of the compensation voltage between the sub-display areas.

According to one or more embodiments of the present disclosure, it is possible to prevent a phenomenon that a luminance difference is visually recognized in a boundary between adjacent sub-display areas with different refresh rates, by gradually changing a difference in voltage level of the compensation voltage at the boundary between the sub-display areas.

According to one or more embodiments of the present disclosure, by adjusting the compensation voltage in units of pixel line in conjunction with a pixel driving frequency, it is possible to accurately control luminance in units of pixel line when the pixel driving frequency is made different.

According to one or more embodiments of the present disclosure, by gradually changing the voltage levels of the first compensation voltage and/or the second compensation voltage in the voltage variable interval between the sub-display areas, it is possible to prevent a luminance difference caused by a difference in threshold voltage of a driving element between a sub-display area with a high refresh rate and a sub-display area with a low refresh rate from being visually recognized at the boundary between adjacent sub-display areas with different refresh rates.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a display panel in which a plurality of data lines, a plurality of gate lines, a plurality of power lines, and a plurality of pixel lines are provided;
a data driver electrically connected to the data lines;
a gate driver electrically connected to the gate lines;
a power supply configured to drive the display panel and configured to vary voltage levels of one or more compensation voltages in response to voltage control data within a voltage variable interval; and
a timing controller configured to control the data driver, the gate driver, and the power supply,
wherein the display panel includes:
a first sub-display area including a plurality of pixel lines to which the compensation voltage at a first voltage level is applied; and
a second sub-display area including a plurality of pixel lines to which the compensation voltage at a second voltage level is applied,
wherein some pixel lines of the first sub-display area and some pixel lines of the second sub-display area are driven within the voltage variable interval, and
wherein the compensation voltage increases or decreases between the first voltage level and the second voltage level within the voltage variable interval.

2. The display device of claim 1, wherein four to sixteen pixel lines are driven within the voltage variable interval, and
a voltage level of the compensation voltage that changes in units of one or sixteen horizontal periods gradually increases or decreases between the first voltage level and the second voltage level within the voltage variable interval.

3. The display device of claim 1, wherein a scanning starts in one of the first sub-display area and the second sub-display area within the voltage variable interval.

4. The display device of claim 1, wherein the voltage variable interval becomes greater as a difference between a refresh rate of the first sub-display area and a refresh rate of the second sub-display area becomes greater.

5. The display device of claim 1, wherein the power lines include a plurality of compensation voltage lines parallel to the gate lines.

6. The display device of claim 5, wherein, while the compensation voltage having the first voltage level is applied to the compensation voltage lines of the first sub-display area, the compensation voltage having the second voltage level is applied to the compensation voltage lines of the second sub-display area.

7. The display device of claim 1, wherein the power supply is configured to output:
the compensation voltage having the first voltage level; and
the compensation voltage having the second voltage level, and
wherein the timing controller changes the voltage control data within the voltage variable interval.

8. The display device of claim 7, wherein the power lines include a plurality of compensation voltage lines parallel to the gate lines,
wherein the gate driver includes a voltage selection circuit electrically connected to the plurality of compensation voltage lines, and
wherein the voltage selection circuit is configured to select the first voltage level and the second voltage level based on a refresh rate.

9. The display device of claim 1, wherein the one or more compensation voltages include a first compensation voltage and a second compensation voltage,
wherein each of the pixel lines includes a plurality of subpixels,
wherein each of the subpixels includes:
a driving transistor including a gate electrode connected to a first node, a first electrode connected to a second node, and a second electrode connected to a third node;
a light-emitting diode including an anode electrode connected to a fourth node and a cathode electrode connected to a second power line to which a pixel ground voltage is applied;
a first switch transistor connected between the first node and the third node and turned on in response to a first scan signal;
a second switch transistor connected between a corresponding data line and the second node and turned on in response to a second scan signal;
a third switch transistor connected between a first power line to which a pixel driving voltage is applied and the second node and turned on in response to an emission control signal;
a fourth switch transistor connected between the third node and the fourth node and turned on in response to the emission control signal;
a fifth switch transistor connected between the second node and a third power line to which the first compensation voltage is applied and turned on in response to a third scan signal to apply the first compensation voltage to the second node;
a sixth switch transistor connected between the fourth node and a fourth power line to which the second compensation voltage is applied and turned on in response to a third scan signal to apply the second compensation voltage to the fourth node; and
a seventh switch transistor connected between the first node and a fifth power line to which an initialization voltage is applied and turned on in response to a fourth scan signal,
wherein at least one of the third power line and the fourth power line is a compensation voltage line, which is separated in units of one or more pixel lines, and
wherein the compensation voltage of different voltage levels is applied to pixel lines having different driving frequencies via the compensation voltage line.

10. The display device of claim 1, wherein the one or more compensation voltages include a first compensation voltage and a second compensation voltage,
wherein each of the pixel lines includes a plurality of subpixels,
wherein each of the subpixels includes:
a driving transistor including a gate electrode connected to a first node, a first electrode connected to a second node, and a second electrode connected to a third node;
a light-emitting diode including an anode electrode connected to a fourth node and a cathode electrode connected to a second power line to which a pixel ground voltage is applied;
a first switch transistor connected between the first node and the third node and turned on in response to a first scan signal;
a second switch transistor connected between a corresponding data line and the second node and turned on in response to a second scan signal;
a third switch transistor connected between a first power line to which a pixel driving voltage is applied and the second node and turned on in response to an emission control signal;
a fourth switch transistor connected between the third node and the fourth node and turned on in response to the emission control signal;
a fifth switch transistor connected between the second node and a third power line to which the first compensation voltage and an initialization voltage are applied and turned on in response to a third scan signal to apply the first compensation voltage and the initialization voltage to the third node; and
a sixth switch transistor connected between the fourth node and a fourth power line to which the second compensation voltage is applied and turned on in response to the third scan signal to apply the second compensation voltage to the fourth node,
wherein at least one of the third power line and the fourth power line is a compensation voltage line, which is separated in units of one or more pixel lines, and
wherein the compensation voltage of different voltage levels is applied to pixel lines having different driving frequencies via the compensation voltage line.

11. The display device of claim 9, wherein a refresh rate of the first sub-display area is different from a refresh rate of the second sub-display area, and
wherein the first compensation voltage increases within the voltage variable interval.

12. The display device of claim 9, wherein a refresh rate of the first sub-display area is different from a refresh rate of the second sub-display area, and
wherein the second compensation voltage decreases within the voltage variable interval.

13. A display device comprising:
a display panel in which a plurality of data lines, a plurality of gate lines, a plurality of power lines, and a plurality of pixel lines are provided;
a data driver electrically connected to the data lines;
a gate driver electrically connected to the gate lines;
a power supply configured to drive the display panel and configured to vary voltage levels of one or more compensation voltages in response to voltage control data; and
a timing controller configured to control the data driver, the gate driver, and the power supply,
wherein the display panel includes:
a first sub-display area including a plurality of pixel lines that are driven at a first refresh rate; and
a second sub-display area including a plurality of pixel lines that are driven at a second refresh rate, and
wherein on-bias periods during which the compensation voltage is applied to the pixel lines are sequentially shifted in the first sub-display area and the second sub-display area along a scanning direction of the display panel.

14. The display device of claim 13, wherein a voltage level of the compensation voltage is simultaneously changed in the first sub-display area and the second sub-display area.

15. A method of driving a display device, the method comprising:
while driving pixel lines of a first sub-display area to display an image at a first refresh rate in the first sub-display area, driving pixel lines of a second sub-display area to display the image at a second refresh rate in the second sub-display area;
setting a compensation voltage that is applied to the pixel lines of the first sub-display area, as a first voltage level;
setting a compensation voltage that is applied to the pixel lines of the second sub-display area, as a second voltage level; and
setting a boundary area including some pixel lines of the first sub-display area and some pixel lines of the second sub-display area as a voltage variable interval,
wherein the compensation voltage increases or decreases between the first voltage level and the second voltage level within the voltage variable interval.

16. The method of driving a display device of claim 15, wherein a scanning starts in one of the first sub-display area and the second sub-display area within the voltage variable interval.

17. The method of driving a display device of claim 15, wherein the voltage variable interval becomes greater as a difference between a refresh rate of the first sub-display area and a refresh rate of the second sub-display area becomes greater.

18. The method of driving a display device of claim 15, wherein a refresh rate of the first sub-display area is different from a refresh rate of the second sub-display area, and
wherein the compensation voltage includes a first compensation voltage that increases within the voltage variable interval.

19. The method of driving a display device of claim 18, wherein the compensation voltage further includes a second compensation voltage that decreases within the voltage variable interval.

20. The method of driving a display device of claim 15, the method further comprising:
shifting an on-bias period during which the compensation voltage is applied to the pixel lines in the first sub-display area and the second sub-display area along a scanning direction of a display panel of the display device.
